(19) United States
(12) Patent Application Publication
(10) Pub. No.: US 2020/0409430 A1
(43) Pub. Date: Dec. 31, 2020

(54) HINGE ASSEMBLIES FOR COMPUTING DEVICES

(71) Applicant: Hewlett-Packard Development Company, L.P., Spring, TX (US)

(72) Inventors: Kuan-Ting Wu, Taipei City (TW); Wei-Chung Chen, Taipei City (TW)

(73) Assignee: Hewlett-Packard Development Company, L.P., Spring, TX (US)

(21) Appl. No.: 16/980,933

(22) PCT Filed: Mar. 23, 2018
(86) PCT No.: PCT/US2018/023984

§ 371 Date: Sep. 15, 2020

(51) Int. Cl. G06F 1/16; E05D 3/02; E05D 11/08; E05D 11/10

(52) U.S. Cl. CPC G06F 1/1681; E05D 3/02; E05D 11/087; E05D 11/1007; E05Y 2201/222; E05Y 2900/606; E05Y 2800/678; E05Y 2201/218; E05Y 2800/46; G06F 1/1616

(57) ABSTRACT

In an example, a hinge assembly to pivotably support a display panel of a computing device relative to a base of the computing device includes a first portion that can lock with a second portion. A resilient member is disposed on one of the first portion and the second portion.

### BACKGROUND

A hinge assembly may be used in a computing device, such as a laptop computer, for pivoting a display panel of the computing device relative to a base of the computing device.

### BRIEF DESCRIPTION OF DRAWINGS

The following detailed description references the figures, wherein:

FIG. 1 illustrates a side view of a computing device having an example hinge assembly, according to an example implementation of the present subject matter;

FIG. 2 illustrates a hinge assembly for a computing device, according to an example implementation of the present subject matter;

FIG. 3 illustrates a rotary member and a stationary member of a hinge assembly, according to an example implementation of the present subject matter,

FIG. 4 illustrates a hinge assembly, according to an example implementation of the present subject matter; and

FIG. 5 illustrates mounting of a dip on a shaft, according to an example implementation of the present subject matter.

### DETAILED DESCRIPTION

A hinge assembly may be used to pivotably support a display panel of a computing device relative to a base of the computing device. The display panel may be supported at any angle ranging from about 0° (when the display panel is closed over the base) to about 180° (and in some cases, about 360°) relative to the base by the hinge assembly.

Generally, parts of the hinge assembly may rotate relative to each other to allow the display panel to be moved to different positions relative to the base. At times, the parts may be locked with each other at certain positions of the display panel. The locking ensures that the display panel does not move relative to the base inadvertently. To move the display panel from its locked position, an excess force is to be applied to the parts of the hinge assembly. The application of the excess force causes a large amount of friction between the parts, which, in turn, may cause noise and wear of the parts.

The present subject matter relates to hinge assemblies usable in computing devices. With the implementations of the present subject matter, noise and wear of components of the hinge assemblies can be reduced.

In accordance with an example implementation, a computing device includes a base, a display panel pivotable relative to the base, and a hinge assembly to pivot the display panel relative to the base. The hinge assembly includes a first member attached to the display panel and a second member coupled to the base. The first member can be, for example, a rotary member coupled to a bracket on which the display panel is mounted, or a shaft. The second member can be, for example, a stationary member that can be in contact with the rotary member. Alternatively, the second member may be a dip having an opening at its center through which the shaft can pass through.

The first member includes a first surface to be locked with a second surface of the second member to lock the first member with the second member. The first surface and the second surface may be, for example, a face of the rotary member and a face of the stationary member, respectively, that face each other. To achieve the locking, the first surface includes a first portion and the second surface includes a second portion. The first portion can be locked with the second portion. The first portion may be, for example, a recess, while the second portion may be, for example, a protrusion.

A resilient member may be fixed to and disposed on the first portion. The resilient member extends on a part of the first surface. For example, the resilient member may extend on a part of a circumference of the first surface. The resilient member may be made of, for example, rubber. Instead of the first portion, the resilient member may be disposed on the second portion and may extend on a part of the second surface.

When the first member is locked with the second member, the resilient member is between the first portion and the second portion. Thus, direct contact between the first portion and the second portion is avoided. This eliminates excess friction between the first portion and the second portion when they are locked with each other, thereby reducing noise and wear of the first and second portions. This improves the durability of the first and second members.

The following description refers to the accompanying drawings. Wherever possible, the same reference numbers are used in the drawings and the following description to refer to the same or similar parts. While several examples are described in the description, modifications, adaptations, and other implementations are possible and are intended to be covered herein.

Example implementations of the present subject matter are described with regard to hinge assemblies for laptop computers. Although not described, it will be understood that the implementations of the present subject matter can be used for other types of computing devices in which one member is to be pivoted relative to another member.

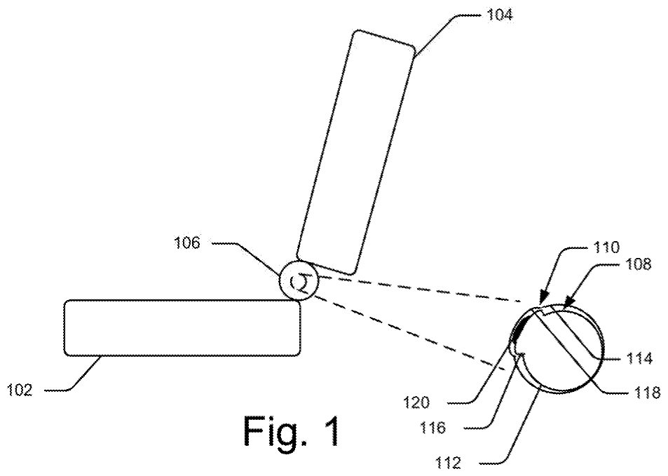

FIG. 1 illustrates a side view of a computing device 100, according to an example implementation of the present subject matter. The computing device 100 can be, for example, a laptop computer. The computing device 100 includes a base 102 and a display panel 104. The base 102 may include components, such as a keyboard, trackpad, and other electronic components (not shown in FIG. 1), while the display panel 104 may include a display unit (not shown in FIG. 1). The computing device 100 further includes a hinge assembly 106, which can pivotably support the display panel 104 on the base 102. The hinge assembly 106 can enable pivoting the display panel 104 at an angle between about 0° and about 180° (and in some cases, about 360°), and angles therebetween, relative to the base 102. The hinge assembly 106 may extend axially in a direction that is perpendicular to a plane having the side view of the computing device 100 and extend circumferentially along the plane having the side view of the computing device 100.

The hinge assembly 106 includes a first member 108 and a second member 110. The first member 108 may be attached to the display panel 104, while the second member 110 may be coupled to the base 102 (attachment and coupling not shown in FIG. 1). Accordingly, the first member 108 can move along with the display panel 104, for example, when a rotating force is applied on the display panel 104. The second member 110 remains stationary when the display panel 104 is moved.

A first surface 112 of the first member 108 is in contact with a second surface 114 of the second member 110. The contact between the first surface 112 and the second surface 114 provides a resistive torque for the rotation of the display panel 104. The resistive torque ensures that the display panel 104 can remain stationary at an angle relative to the base 102, and does not move when a rotating force on the display panel 104 is removed.

The first member 108 and the second member 110 may be locked with each other at a particular position of the display panel 104 relative to the base 102. The first member 108 may be moved from its locked position by applying additional force to the display panel 104. The position may be, for example, a closed position of the display panel 104 on the base 102, i.e., when the display panel 104 is at about a 0° angle relative to the base 102. The locking of the display panel 104 at the closed position ensures that the display panel 104 does not move inadvertently, for example, due to accidental jerks and disturbances. To move the display panel 104 from the closed position, a force to be applied to the display panel 104 is slightly larger than the force to be applied to move the display panel 104 from its other positions. This ensures that the display panel 104 does not open when the computing device 100 is being carried from one place to another in closed position.

To lock the first member 108 and the second member 110, the first surface 112 and the second surface 114 may be locked with each other. For this, the first surface 112 includes a first portion 116 and the second surface 114 includes a second portion 118. The first portion 116 and the second portion 118 can lock with each other, as illustrated in FIG. 1. Although the first portion 116 and the second portion 118 are shown to be locked with each other when the display panel 104 is at an angle of about 90° relative to the base 102, in other examples, the locking may be performed in other positions of the display panel 104 relative to the base 102, such as in a closed position of the display panel 104. To enable locking at a particular position of the display panel 104, the first member 108 and the second member 110 may be arranged such that the first portion 116 and the second portion 118 mate with each other at that position. Further, although the locking is illustrated as between the first portion 116 and the second portion 118, in an example, the first surface 112 may include a third portion and the second surface 114 may include a fourth portion. The third portion may lock with the fourth portion to lock the first surface 112 with the second surface 114 in a second position. In further examples, the first surface 112 and the second surface 114 may each include additional portions that can lock with each other at different positions.

A resilient member 120 may be disposed on the first portion 116. As the name suggests, the resilient member 120 can deform when compressed or otherwise deformed and can come back to its original shape when no longer deformed. In an example, the resilient member 120 may be made of rubber. The resilient member 120 may be fixed on the first portion 116, for example, by insert molding.

The resilient member 120 may extend on a part of the first surface 112. As will be understood, a member extending on a part of a surface refers to the member being present on the part of the surface, while being absent on a remainder of the surface. For example, the resilient member 120 may extend on a part of a circumference of the first surface 112, as illustrated. To extend on a part of the first surface 112, the resilient member 120 may be disposed on the first portion 116, and nowhere else on the first surface 112.

In an example, instead of the first portion 116, a resilient member (not shown in FIG. 1) may be disposed on the second portion 118. Such a resilient member may extend on a part of the second surface 114. In a further example, a resilient member may be disposed on both the first portion 116 and the second portion 118.

When the first member 108 is locked with the second member 110 due to the locking of the first portion 116 and the second portion 118, the resilient member 120 is between the first portion 116 and the second portion 118, as illustrated. Therefore, if there is a small movement of the first member 108 relative to the second member 110 when they are locked with each other, the resilient member 120 reduces excessive friction between the first portion 116 and the second portion 118. Thus, the present subject matter prevents noise and wear of the first member 108 and the second member 110 due to disturbances, jerks, or the like when they are locked with each other. Also, even if an excess force is applied to overcome the locking between the first member 108 and the second member 110, for example, to open the display panel 104, the resilient member 120 ensures that the friction between the first portion 116 and the second portion 118 is not excessive. Overall, the resilient member 120 minimizes noise and wear of the first member 108 and the second member 110 due to any relative movement between them.

It is to be noted that the first member 108 and second member 110 illustrated in FIG. 1 are examples, and other types of the first member 108 and the second member 110 are possible as well. For example, the first member 108 may be a rotary disk and the second member 110 may be a stationary member. In another example, the first member 108 may be a shaft and the second member 110 may be a clip. According to the type of the first member 108 and the second member 110, the geometry of the first surface 112, second surface 114, first portion 116, and the second portion 118 may also vary. Some different types of the first member 108, second member 110, first surface 112, second surface 114, first portion 116, and second portion 118 will be explained with reference to subsequent figures.

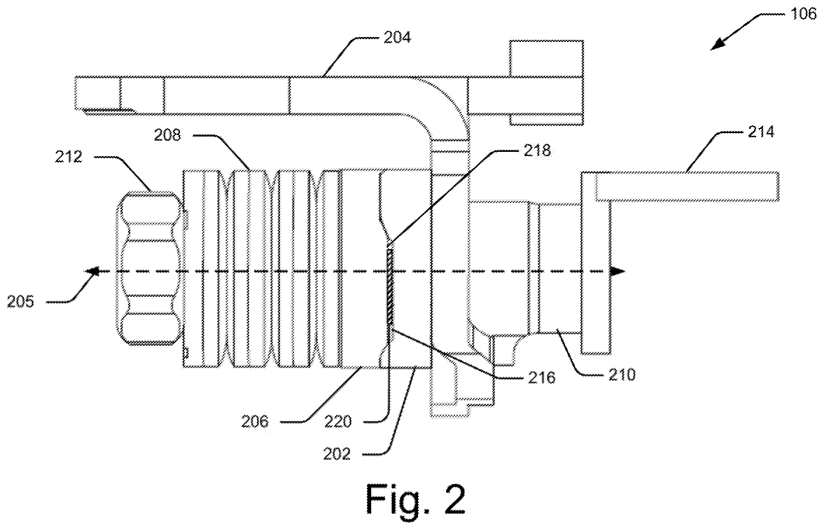

FIG. 2 illustrates the hinge assembly 106, according to an example implementation of the present subject matter. The hinge assembly 106 includes a rotary member 202, which corresponds to the first member 108. The rotary member 202 may be disk-shaped, and may be referred to as rotary disk 202. However, it is to be understood that the rotary member 202 may assume other shapes as well.

The rotary disk 202 may be attached to a display bracket 204 on which the display panel 104 (not shown in FIG. 2) can be mounted. Accordingly, when the display panel 104 is rotated relative to the base 102 (not shown in FIG. 2), the rotary disk 202 rotates about an axis of the hinge assembly 106. A direction in which the axis of the hinge assembly extends may be referred to as an axial direction 205 of the hinge assembly 106. In the view of the hinge assembly 106 illustrated in FIG. 2, the axial direction 205 extends in a left-hand side and right-hand side direction. The hinge assembly 106 also includes a stationary member 206, which corresponds to the second member 110. As illustrated, the stationary member 206 may be displaced from the rotary member 202 in the axial direction 205 of the hinge assembly 106. For instance, the stationary member 206 may be disposed to the left-hand side of the rotary member 202 in the view of the hinge assembly 106 illustrated in FIG. 2.

The stationary member 206 may have a similar shape as that of the rotary disk 202, such as a disk shape, and may have a similar diameter as that of the rotary disk 202. Accordingly, the stationary member 206 may be referred to as the stationary disk 206. The stationary disk 206 may be coupled to the base 102, and may remain stationary relative to the rotary disk 202 when the rotary disk 202 rotates about the axis of the hinge assembly 106. The hinge assembly 106 further includes an elastic member 208 adjacent to a surface of the stationary disk 206 that is away from the rotary disk 202. The elastic member 208 may urge the stationary disk 206 towards the rotary disk 202.

Each of the rotary disk 202, display bracket 204, stationary disk 206, and elastic member 208 includes a through-hole (not shown in FIG. 2) at their respective centers. A pivot shaft 210 passes through the through-holes in an assembled state of the rotary disk 202, the display bracket 204, the stationary disk 206, and the elastic member 208, of the hinge assembly 106. At an end of the pivot shaft 210 near the elastic member 208, a nut 212 can be fastened to keep the components assembled. Further, at an end of the pivot shaft 210 away from the elastic member 208, i.e., at the end near the display bracket 204, a base bracket 214 may be provided. The base bracket 214 may be attached to the base 102.

The rotary disk 202 includes a first portion 216. The first portion 216 can be, for example, a recess. The first portion 216 may be interchangeably referred to as the recess 216. However, it is to be understood that the first portion 216 may be implemented in other manners as well. Further, the stationary disk 206 includes a second portion 218, corresponding to the second portion 118. The second portion 218 can be, for example, a protrusion that is complementary to the recess. The second portion 218 may be interchangeably referred to as the protrusion 218, although the second portion 218 may be implemented in other manners as well. As illustrated, the first portion 216 and the second portion 218 can be locked with each other.

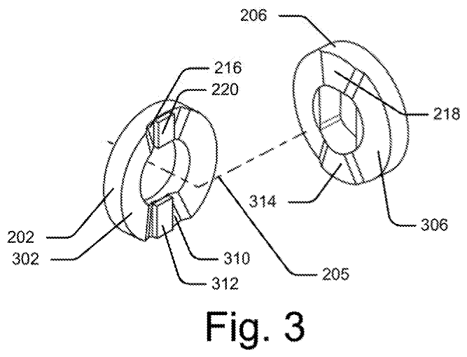

A resilient member 220 is disposed on the first portion 216. In another example, the resilient member 220 may be disposed on the second portion 218. In a further example, the resilient member 220 can be disposed on both the first portion 216 and the second portion 218. The first portion 216, the second portion 218, and the resilient member 220 will be explained with reference to FIG. 3.

FIG. 3 illustrates the rotary disk 202 and the stationary disk 206, according to an example implementation of the present subject matter. The rotary disk 202 includes the recess 216. The recess 216 may be part of a first surface 302 of the rotary disk 202. For example, the recess 216 may extend inward in a thickness direction of the rotary disk 202 from the remainder of the first surface 302. The first surface 302 may be a face of the rotary disk 202 that faces the stationary disk 206.

The stationary disk 206 includes a second surface 306. The second surface 306 may be a face of the stationary disk 206 that faces the first surface 302, and is away from the elastic member 208. The second surface 306 includes the protrusion 218. For example, the protrusion 218 can extend outward in a thickness direction of the stationary disk 206 from the remainder of the second surface 306.

When the hinge assembly 106 is assembled, the first surface 302 and the second surface 306 may be in contact with each other. Further, as mentioned earlier, when the hinge assembly 106 is assembled, the rotary disk 202 is displaced from the stationary disk 206 in the axial direction 205 of the hinge assembly 106. For this, in an example, the first surface 302 may be disposed adjacent to the second surface 306 in the axial direction 205.

In an example, the recess 216 and the protrusion 218 are complementary to each other, and can lock with each other. For example, the recess 216 can accommodate the protrusion 218, thereby locking itself with the protrusion 218. Therefore, when the display panel 104 is to be moved from its locked position, an additional amount of force is to be applied on the display panel 104, so that the recess 216 can move out of the protrusion 218, against the urge provided by the elastic member 208.

In an example, the resilient member 220 may be disposed on the recess 216. The resilient member 220 may extend on a part of the first surface 302. For example, the resilient member 220 may be present on a part of the first surface 302, and absent on a remainder of the first surface 302. For this, the resilient member 220 may be disposed on the recess 216 alone, and nowhere else on the first surface 302. The extension of the resilient member 220 on a part of the first surface 302 reduces the size of the resilient member 220 to be used.

When the display panel 104 is rotated, the display bracket 204 moves along with it. This causes the rotation of the rotary disk 202. During the rotation of the rotary disk 202, at a particular position, the recess 216 may get locked with the protrusion 218 of the stationary disk 206. At this position, the resilient member 220 lies between the recess 216 and the protrusion 218.

Although not shown in FIG. 3, in an example, the resilient member 220 may be disposed on the second portion 218, instead of the first portion 216. In such a case, the resilient member 220 may extend on a part of the second surface 306 of the stationary disk 206. For this, the resilient member 220 may be disposed on the second portion 218 alone, and nowhere else on the second surface 306. In a further example, the resilient member 220 may be disposed both on the recess 216 and the protrusion 218.

In an example, in addition to the first portion 216, the first surface 302 includes a third portion 310 similar to the first portion 216. The third portion 310 may be provided diametrically opposite the first portion 216 on the first surface 302. A second resilient member 312 may be disposed on the third portion 310. Corresponding to the third portion 310, the second surface 306 includes a fourth portion 314, similar to the second portion 218 and diametrically opposite the second portion 218. The third portion 310 and the fourth portion 314 can lock with each other. As will be understood, during rotation of the display panel 104, the first portion 216 and the fourth portion 314 may also lock with each other, while the third portion 310 and the second portion 218 may also lock with each other, thereby defining an additional locked position of the display panel 104.

As mentioned earlier, in some examples, the first member 108 may be a shaft and the second member 110 may be a clip. The clip may have an opening through which the shaft can pass through to couple the first member 108 with the second member 110. This will be explained with reference to subsequent figures.

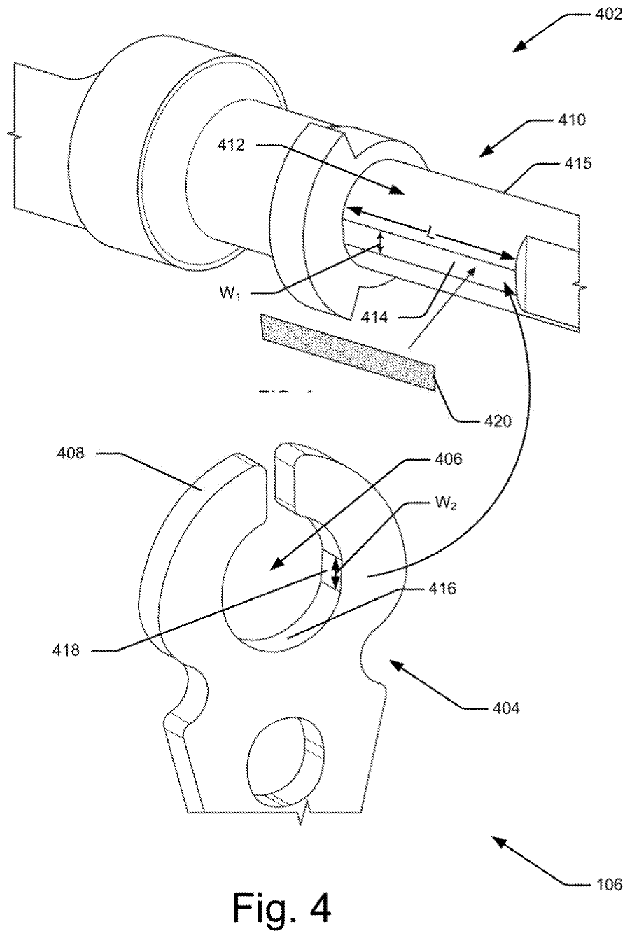

FIG. 4 illustrates the hinge assembly 106, according to an example implementation of the present subject matter. The hinge assembly 106 may be a friction hinge assembly, in which friction between two bodies provide the resistive torque between the display panel 104 and the base 102.

The hinge assembly 106 includes a shaft 402 and a clip 404. A length of the shaft 402 may extend parallel to an axial direction of the hinge assembly 106. The shaft 402 may pass through an opening 406 at the center or at a central portion of the clip 404 to mount the clip 404 on the shaft 402. Further, the shaft 402 may tightly fit in the opening 406, and remain frictionally engaged with the clip 404. The shaft 402 may be connected to the display panel 104 for rotating along with the display panel 104. For this, the shaft 402 may be coupled to a first housing (not shown in FIG. 4) mounted on the display panel 104. Further, the clip 404 may be coupled to base 102. For this coupling, an outer surface 408 of the clip 404 may be in contact with a second housing (not shown in FIG. 4) mounted on the base 102.

When the display panel 104 rotates, the shaft 402 also rotates, while the clip 404 is stationary. This causes a relative rotation between the shaft 402 and the clip 404. Since the shaft 402 is frictionally engaged with the clip 404, the rotation of the shaft 402 provides a resistive torque for the rotation. To provide additional resistive torque for the rotation, more clips (not shown in FIG. 4) similar to the clip 404 may be mounted on the shaft 402. For example, if a resistive torque of 4 Kgf-cm is to be provided and each clip can provide a resistive torque of 0.4 Kgf-cm, ten clips may be provided in the hinge assembly 106.

The shaft 402 includes a clip-mounting region 410 on which the clip 404 and other clips can be mounted. The dip-mounting region 410 may be substantially cylindrical in shape and includes a first surface 412. The first surface 412 may be an outer surface of the clip-mounting region 410. The first surface 412 may include a first portion 414. In an example, the first portion 414 may be rectangular in shape and a length L of the first portion 414 may extend in a longitudinal direction of shaft 402, as illustrated. The presence of the rectangle-shaped first portion 414 on the first surface 412 causes the cross section of the clip-mounting region 410 to be D-shaped. Accordingly, a circumference 415 of the first surface 412 has a D-shape.

The dip 404 includes a second surface 416, which may be an inner surface of the clip 404. The second surface 416 comes in contact with the first surface 412 when the clip 404 is mounted on the shaft 402. The contact between the second surface 416 and the first surface 412 provides the frictional engagement between the shaft 402 and the clip 404.

The second surface 416 may include a second portion 418. The second portion 418 can lock with the first portion 414 when the clip 404 is mounted on the shaft 402. For this, the second portion 418 can have a shape corresponding to that of the first portion 414. For example, when the first portion 414 is rectangular in shape, the second portion 418 may also be rectangular in shape. In an example, for the locking, the width W1 of the first portion 414 may be same as or similar to the width W2 of the second portion 418.

A resilient member 420, corresponding to the resilient member 120 and the resilient member 220, may be disposed on the first portion 414. The resilient member 420 may extend on a part of the first surface 412 along the circumference 415 of the first surface 412. Stated otherwise, the resilient member 420 may be present on a part of the circumference 415, and not on a remainder of the circumference 415. For instance, the resilient member 420 may be disposed on the first portion 414 alone, and not on any other portion along the circumference 415 of the first surface 412. For this, the resilient member 420 may have the same shape and dimensions as the first portion 414. For example, the resilient member 420 may be rectangular in shape having a length L and width W1.

As will be understood, the shaft 402 can rotate when the display panel 104 (not shown in FIG. 4) is rotated and can lock with the clip 404 when the first portion 414 comes in contact with the second portion 418. As mentioned earlier, such a locking may happen when the display panel 104 is closed on the base 102 (not shown in FIG. 4). Upon locking, if the display panel 104 is to be rotated, for example, to open the display panel 104, a slightly excessive force is to be applied to the display panel 104, so that the first portion 414 can be moved away from the second portion 418.

When the first portion 414 is locked with the second portion 418, the resilient member 420, disposed on the first portion 414, is present between the first portion 414 and the second portion 418. As explained earlier, this reduces noise and wear of the shaft 402 and the clip 404.

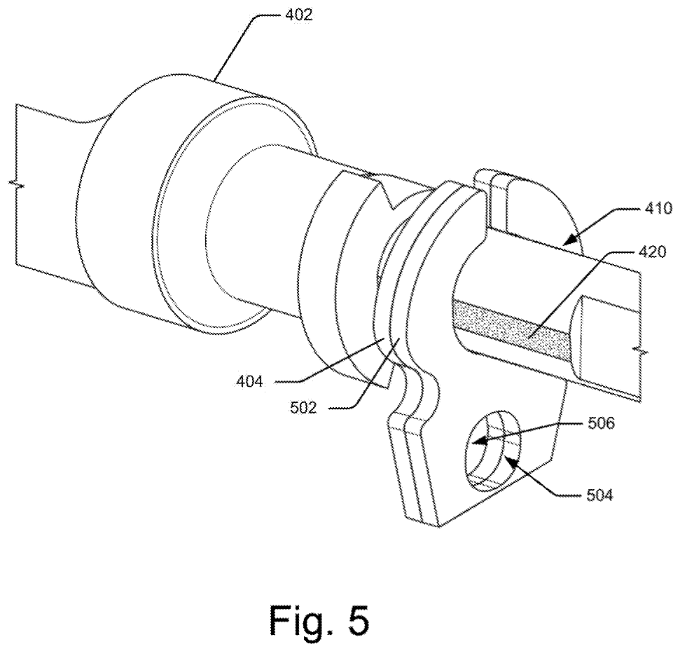

In an example, in addition to the first portion 414, the shaft 402 may include a third portion (not shown in FIG. 4) similar to the first portion 414. The third portion may be disposed diametrically opposite the first portion 414 on the shaft 402. Corresponding to the third portion, the clip 404 may include a fourth portion similar to the second portion 418. The fourth portion may be disposed diametrically opposite the second portion 418. The third portion may get locked with the fourth portion during rotation of the shaft 402. A resilient member may be disposed on the third portion as well, so that the resilient member is present between the third portion and the fourth portion during locking. The mounting of the clip 404 on the shaft 402 will be explained with reference to FIG. 5.

FIG. 5 illustrates mounting of the clip 404 on the shaft 402, according to an example implementation of the present subject matter. The shaft 402 can pass through the opening 406 (not visible in FIG. 5) to mount the clip 404 on the shaft 402. Upon mounting, when the shaft 402 rotates, the clip 404 resists the rotation, providing resistive torque for the rotation. To provide additional resistive torque, additional dips may be provided. For instance, the hinge assembly 106 may include a second clip 502 that can be mounted on the shaft 402. The second dip 502 may be disposed adjacent to the clip 404 such that a face (not visible in FIG. 5) of the second clip 502 is in contact with a face (not visible in FIG. 5) of the clip 404. If the hinge assembly 106 includes the second clip 502, the clip 404 may be referred to as first clip 404.

The second clip 502 includes an opening (not visible in FIG. 5) similar to the opening 406 through which the shaft 402 can pass. The opening of the second clip 502 and the opening 406 together form a channel through which the shaft 402 can pass through. For assembling the hinge assembly 106, the first clip 404, the second clip 502, and any other clip that is to be part of the hinge assembly 106 may be arranged adjacent to each other and aligned with each other. The first clip 404, second clip 502, and any other clip of the hinge assembly 106 may be collectively referred to as a plurality of clips.

The alignment of the plurality of clips may be performed to ensure that the second portion 418 of the plurality of clips are aligned with each other. Such an alignment allows the shaft 402 to get locked with the plurality of clips at the same time. To enable alignment of the plurality of clips, each clip includes an alignment opening. For example, the second clip 502 includes an alignment opening 504 and the first clip 404 includes an alignment opening 506 (behind the alignment opening 504). The alignment openings 504 and 506 may have a smaller diameter than that of the opening 406 and may be disposed below the opening 406. When the alignment openings of the plurality of clips are aligned with each other, it can be ensured that the plurality of clips are property aligned with each other as well.

Upon alignment of the plurality of dips, the shaft 402 can be passed through the channel formed by the plurality of clips. Specifically, the clip-mounting region 410 of the shaft can be passed through the channel. Thereafter, when the shaft 402 rotates, a relative motion exists between the plurality of clips and the shaft 402. Further, the first portion 414 can get locked with the second portion 418 of each clip of the plurality of clips at a particular position, such as at the closed position, of the display panel 104, as illustrated in FIG. 5. During locking, the resilient member 420 is between the first portion 414 and the second portions 418, thereby preventing noise and wear of the shaft 402 and the plurality of clips.

The hinge assemblies of the present subject matter reduce noise when a display panel of a computing device is rotated relative to a base of the computing device. Specifically, the hinge assemblies reduce noise when a first member of the display panel is locked at a particular position relative to a second member of the base. This reduces wear of the first member and the second member, and increases their durability. Therefore, the durability of the hinge assemblies, having the first member and the second member, is increased.

Although implementations of hinge assembly have been described in language specific to structural features, it is to be understood that the present subject matter is not necessarily limited to the specific features described. Rather, the specific features are disclosed and explained as example implementations.

We claim:

1. A computing device comprising:
a base;
a display panel; and
a hinge assembly to pivotably support the display panel on the base, the hinge assembly comprising:
a first member attached to the display panel to move with the display panel, the first member comprising a first surface having a first portion;
a second member coupled to the base and comprising a second surface to be locked with the first surface, the second surface having a second portion being lockable with the first portion; and
a resilient member fixedly disposed on one of the first portion and the second portion and extending on a part of one of the first surface and the second surface.

2. The computing device of claim 1, wherein the resilient member is made of rubber.

3. The computing device of claim 1, wherein the second portion is to lock with the first portion in response to the display panel being closed over the base.

4. The computing device of claim 1, wherein
the first member is a rotary disk, and
the second member is a stationary disk.

5. The computing device of claim 1, wherein
the first member is a shaft,
the second member is a dip, the clip having an opening through which the shaft is to pass through,
the first surface is an outer surface of the shaft, and
the resilient member extends on a part of a circumference of the outer surface.

6. A hinge assembly to pivot a display panel of a computing device relative to a base of the computing device, the hinge assembly comprising:
a rotary member having a first surface, the first surface having a first portion;
a stationary member displaced from the rotary member in an axial direction of the hinge assembly and having a second surface that is in contact with the first surface, the second surface having a second portion being lockable with the first portion to lock the rotary member with the stationary member; and
a resilient member disposed on one of the first portion and the second portion and extending on a part of one of the first surface and the second surface.

7. The hinge assembly of claim 6, wherein the first portion is a recess.

8. The hinge assembly of claim 6, wherein the second portion is a protrusion.

9. The hinge assembly of claim 6, wherein the first surface comprises a third portion and the second surface comprises a fourth portion, the third portion being lockable with the fourth portion.

10. The hinge assembly of claim 9, wherein the first portion is lockable with the fourth portion and the second portion is lockable with the third portion.

11. The hinge assembly of claim 6, wherein the rotary member is attachable to a display bracket on which the display panel is to be mounted and the stationary member is couplable to the base.

12. A hinge assembly to pivot a display panel of a computing device relative to a base of the computing device, the hinge assembly comprising:
a shaft connectable to the display panel to rotate with the display panel, the shaft comprising a first surface having a first portion;
a clip comprising:
an opening to pass the shaft therethrough; and
a second surface that is in contact with the first surface, the second surface having a second portion that is lockable with the first portion; and
a resilient member disposed on the first portion and extending on a part of the first surface along a circumference of the first surface.

13. The hinge assembly of claim 12, wherein the first portion and the second portion are rectangle-shaped.

14. The hinge assembly of claim 12, comprising a second clip mounted on the shaft.

15. The hinge assembly of claim 14, wherein each of the clip and the second clip comprises an alignment opening to enable aligning the clip and the second clip.
